(19) United States
(12) Patent Application Publication
(10) Pub. No.: US 2024/0283872 A1
(43) Pub. Date: Aug. 22, 2024

(54) METHOD AND APPARATUS FOR CHARGING

(71) Applicant: Telefonaktiebolaget LM Ericsson (publ), Stockholm (SE)

(72) Inventors: Zhansheng WEI, SHANGHAI (CN); Jiehong YANG, Molndal (SE); Robert TORNKVIST, Karlskrona (SE); Anders LARSSON, Molndal (SE); Juan LI, Shanghai (CN); Ting ZHU, SHANGHAI (CN)

(73) Assignee: TELEFONAKTIEBOLAGET LM ERICSSON (PUBL), STOCKHOLM (SE)

(21) Appl. No.: 18/292,754

(22) PCT Filed: Jul. 29, 2022
(86) PCT No.: PCT/CN2022/108909

§ 371 Date: Jan. 26, 2024

(30) Foreign Application Priority Data
Jul. 29, 2021 (WO) PCT/CN2021/109264

(51) Int. Cl. H04M 15/00

(52) U.S. Cl. CPC H04M 15/83; H04M 15/60

(57) ABSTRACT

A method performed by a charging function entity comprises sending a charging notify request comprising at least one information element to a network function entity. The at least one information element is used for determining which quota and/or usage reporting is required to be updated to the charging function entity. The method further comprises receiving a charging notify response from the network function entity. When validation of a part of the at least one information element is failed, the charging notify response comprises a first status code and error information related to the part of the at least one information element.

### TECHNICAL FIELD

The non-limiting and exemplary embodiments of the present disclosure generally relate to the technical field of communications, and specifically to methods and apparatuses for charging.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example NR (new radio) as defined by 3rd Generation Partnership Project (3GPP), there is provided network functions that implement offline and/or online charging mechanisms. In order to support these charging mechanisms, the network functions perform real-time monitoring of resource usage in order to detect relevant chargeable events. In offline charging, the resource usage is reported from a network function entity to a charging function entity after the resource usage has occurred. In online charging, a subscriber account is queried prior to granting permission to use the requested network resource(s). Typical examples of network resource usage are a voice call of certain duration, the transport of a certain volume of data, or the submission of a multimedia (MM) of a certain size. The network resource usage requests may be initiated by a user equipment (UE) (MO (Mobile Originated) case) or by the network (MT (Mobile Terminated) case). Offline and online charging may be performed simultaneously and independently for the same chargeable event.

### SUMMARY

This summary is provided to introduce a selection of concepts in a simplified form that

are further described below in the detailed description. This summary is not intended to identify key features or essential features of the claimed subject matter, nor is it intended to be used to limit the scope of the claimed subject matter.

Converge charging is introduced in 5GC (fifth generation core network). When offline charging and online charging are applicable to a service delivery, charging information of both offline charging (without quota management) and online charging (with quota management) can be provided in a single command. The quota management may be per rating group. The network function such as SMF (Session Management Function) may allow reporting of the service or the detected application usage per rating group or per combination of the rating group and service id (identifier) in N40 interface point. N40 interface point is a reference point between SMF and CHF.

As defined by 3GPP TS 32.290 V17.1.0, the disclosure of which is incorporated by reference herein in its entirety, the CHF (e.g., NF (network function) Service Producer) may trigger a re-authorization request and the NF service consumer (such as SMF) shall report quota usage to the CHF.

FIG. 1 shows a flowchart of session based charging notification with re-authorization. FIG. 1 is same as FIG. 5.3.2.4-1 of 3GPP TS 32.290 V17.1.0.

The CHF can in converged session based charging provide notifications to the NF (CTF (charging trigger function)), the NF (CTF) implicitly subscribes to these when it sends a Charging Data Request [Initial] to CHF, i.e. there is no separate subscription request from the NF for notification.

At step 1. Session based charging ongoing: there is a session based charging ongoing and there have at least been a Charging Data Request [Initial] sent from the NF (CTF) to the CHF, and the CHF have opened a CDR (Charging Data Record).

At step 2. Event triggering notification: an event is detected in the CHF that requires a notification to be sent to the NF (CTF). In this scenario a request for triggering a Charging Data Request [Update, Quota Request] is sent, but also requests for Charging Data Request [Update] (without request for quota) is possible.

At step 3. Charging Notify Request [Re-authorization]: the CHF sends the request to the NF (CTF), for a triggering of a Charging Data Request [Update, Quota Request] i.e. Re-authorization. As defined by 3GPP TS 32.291 V16.7.0, the disclosure of which is incorporated by reference herein in its entirety, there is a ‘quotaManagementIndicator’ defined in the Charging Notify Request message to identify whether the reauthorization notification is for quota management control or not especially when services of the same rating group or service identifier are using different charging methods.

Table 1 describes the data structure which is common to Charging Notify Request. Table 1 is same as Table 7.3 of 3GPP TS 32.290 V17.1.0. URI denotes Uniform Resource Identifier.

TABLE 1
Common Data structure of Charging Notify Request

| | Converged | |
|---|---|---|
| | Charging | |
| Information Element | Category | Description |
| Notify URI | M | This field holds the URI previously supplied by |
| | | the CHF for notifications associated to the |
| | | charging session. |
| Notification type | M | This field holds the type of notification indicating |
| | | re-authorization or termination. |
| Reauthorization Details | O_{C} | This field holds the details of re-authorization. |
| | | It's only present when type of notification |
| | | is re-authorization. If not present and type of |
| | | notification is re-authorization, the re-authorization |
| | | notification applies to all units. |
| Service Identifier | O_{C} | This field holds the Service Identifier to which |
| | | re-authorization notification applies. If present, |
| | | the rating group shall also be present. If not |
| | | present there-authorization notification applies |
| | | to all service identifiers. |
| Rating Group | O_{C} | This field holds the rating group to which re- |
| | | authorization notification applies. If not present |
| | | the re-authorization notification applies to all |
| | | rating groups. |
| Quota management | O_{C} | This field holds an indicator on whether the re- |
| Indicator | | authorization notification is for quota management |
| | | control or not. If not present the re-authorization |
| | | notification applies to both units with and without |
| | | quota management. |

At step 4. Charging Notify Response: the NF (CTF) acknowledges the request by sending a response.

At step 5. Charging Data Request [Update, Quota Requested]: the NF (CTF) sends the request to the CHF, to be granted with more unit for the service to continue, and also for reporting the used units.

At step 6. Account, Rating, Reservation Control: the CHF performs the process related to the reported usage and the requested reservation, involving rating entity and user's account balance.

At step 7. Update CDR: based on policies, the CHF updates the CDR with charging data related to the service.

At step 8. Charging Data Response [Update, Quota Granted]: the CHF grants quota to NF (CTF) for the service to continue, with the reserved number of units.

As defined by 3GPP TS 29.512 V17.2.0, the disclosure of which is incorporated by reference herein in its entirety, the charging method of a rating group or a service identifier is decided by PCF (Policy Control Function) which can be online charging and/or offline charging depending on the PCC (Policy and Charging Control) rule level charging method. Table 2 shows an example of PccRule. Table 2 is a truncated table of Table 5.6.2.6-1 of 3GPP TS 29.512 V17.2.0.

TABLE 2
PccRule

| Attribute | | | | |
|---|---|---|---|---|
| name | Data type | P | Cardinality | Description |
| flowInfos | array(FlowInformation) | C | 1 . . . N | An array of IP flow packet filter information. |
| appId | string | C | 0 . . . 1 | A reference to the application detection |
| | | | | filter configured at the UPF. |
| pccRuleId | string | M | 1 | Univocally identifies the PCC rule within a |
| | | | | PDU session. |
| refChgData | array(string) | O | 1 . . . N | A reference to the ChargingData policy decision |
| | | | | type. It is the chgId described in subclause |
| | | | | 5.6.2.11 of 3GPP TS 29.512 V17.2.0. |

Table 3 shows an example of ChargingData. Table 3 is a truncated table of Table 5.6.2.11 of 3GPP TS 29.512 V17.2.0.

TABLE 3
ChargingData

| Attribute | | | | |
|---|---|---|---|---|
| name | Data type | P | Cardinality | Description |
| offline | boolean | O | 0 . . . 1 | Indicates the offline charging is applicable to |
| | | | | the PCC rule when it is included and set ot true. |
| online | boolean | O | 0 . . . 1 | Indicates the online charging is applicable to |
| | | | | the PCC rule when it is included and set ot true. |
| ratingGroup | RatingGroup | O | 0 . . . 1 | The charging key for the PCC rule used for rating |
| | | | | purposes. |
| serviceId | ServiceId | O | 0 . . . 1 | Indicates the identifier of the service or service |
| | | | | component the service data flow in a PCC rule |
| | | | | relates to. |

It's allowed that some PCC rules share the same rating group. It's allowed that some PCC rules share the same service identification. PCC rules can be activated, deactivated or modified at any time during the PDU session lifetime. The following attribute can be modified by the PCF in a dynamic PCC rule active in the NF (CTF) such as SMF: charging key (rating group) and/or service identifier.

There may be some problems for the charging. For example, when the PCC rules are activated, deactivated or modified, it may lead to at least one of: the charging method of a rating group in NF (CTF) such as SMF is changed, or the service identifier in NF (CTF) such as SMF is changed.

For example, initially, there are two installed/activated PCC rules:

PCC rule 1(rating group 1, service id 1, offline charging),

PCC rule 2(rating group 1, service id 2, online charging).

At some time, PCC rule 2 is removed, and then for rating group 1, there is only offline service exist, and the service id 2 is removed along with the removal of PCC rule 2. But this change can't be aware by CHF. It may cause the information in CHF and NF (CTF) such as SMF is inconsistent. At last, when CHF triggers a charging notify request for example [Re-authorization] with Reauthorization Details information, NF (CTF) such as SMF may not able to handle it.

For example, when the following Charging Data Notification Request is received from CHF, NF (CTF) such as SMF can not handle it because the service 2 is not exist anymore.

```
Charging Data Notification Request (from CHF)
  Charging Data Notification Request (from CHF)
    NotificationType: REAUTHORIZATION
    ReauthorizationDetails
        Service: 2
      RatingGroup: 1
      QuotaManagementIndicator: ONLINE_CHARGING
```

For example, when the following Charging Data Notification Request is received from CHF, NF (CTF) such as SMF can not handle it because the online service is removed and not exist any more.

```
  Charging Data Notification Request (from CHF)
    NotificationType: REAUTHORIZATION
    ReauthorizationDetails
      RatingGroup: 1
      QuotaManagementIndicator: ONLINE_CHARGING
NF (CTF) such as SMF may not able to inform CHF the inconsistence
status.
```

There is another problem for the charging. For example, if the session (such as PDU session) is terminated because some internal errors in NF (CTF) such as SMF and the release is not able to inform to CHF by sending a Charging Data Request-terminate message. When a Charging Data Notification Request message is received from CHF, the message cannot anchor to a session (such as PDU session), NF (CTF) such as SMF shall able to inform CHF the errors with a proper Hypertext Transfer Protocol (HTTP) status code such as 404 Not Found, application Error USER_UNKNOWN. But there is only 400 Bad Request in the OpenAPI as defined by 3GPP TS 32.291 V16.7.0.

To overcome or mitigate at least one of above mentioned problems or other problems, the embodiments of the present disclosure propose an improved solution for charging

In a first aspect of the disclosure, there is provided a method performed by a charging function entity. The method comprises sending a charging notify request comprising at least one information element to a network function entity. The at least one information element is used for determining which quota and/or usage reporting is required to be updated to the charging function entity. The method further comprises receiving a charging notify response from the network function entity. When validation of a part of the at least one information element is failed, the charging notify response comprises a first status code and error information related to the part of the at least one information element.

In an embodiment, an information element may comprise at least one of service identifier, rating group, or quota management indicator.

In an embodiment, the charging notify request may comprise a type of notification indicating re-authorization.

In an embodiment, the first status code may comprise a Hypertext Transfer Protocol (HTTP) 200 OK status code indicating that the charging notify request is partly acknowledged.

In an embodiment, when the charging notify response comprises the first status code, the first charging notify response may further comprise error information related to the part of the at least one information element.

In an embodiment, the error information related to the part of the at least one information element may comprise a failure reason.

In an embodiment, when validation of each of the at least one information element is failed, the charging notify response comprises a second status code and error information related to the at least one information element.

In an embodiment, the second status code may comprise an HTTP 404 Not Found or 400 Bad Request status code.

In an embodiment, the error information related to the at least one information element comprises re-authorization is failed.

In an embodiment, the method may further comprise sending a first message comprising information for indicating at least one supported feature of the charging function entity to the network function entity. The method may further comprise receiving a second message comprising information for indicating at least one supported feature of the network function entity from the network function entity.

In an embodiment, the at least one supported feature may comprise supporting for notification response in a network function consumer.

In an embodiment, the supporting for notification response in the network function consumer may indicate that the notification response supports the first status code, the second status code and the error information.

In an embodiment, the first message may comprise the charging notify request. The second message may comprise the charging notify response.

In an embodiment, the network function entity may be configured with a charging trigger function.

In an embodiment, the network function entity may comprise at least one of Session Management Function (SMF), Packet Data Network Gateway (PGW), PGW control plane (PGW-C), or PGW-C combined with SMF.

In an embodiment, the charging notify request is used for converged session based charging.

In a second aspect of the disclosure, there is provided a method performed by a network function entity. The method comprises receiving a charging notify request comprising at least one information element from a charging function entity. The at least one information element is used for determining which quota and/or usage reporting is required to be updated to the charging function entity. The method further comprises validating the at least one information element. The method further comprises sending a charging notify response to the charging function entity. When validation of a part of the at least one information element is failed, the charging notify response comprises a first status code and error information related to the part of the at least one information element.

In an embodiment, an information element comprises at least one of service identifier, rating group, or quota management indicator.

In an embodiment, the charging notify request comprises a type of notification indicating re-authorization.

In an embodiment, the first status code comprises a Hypertext Transfer Protocol (HTTP) 200 OK status code indicating that the charging notify request is partly acknowledged.

In an embodiment, the error information related to the part of the at least one information element comprises a failure reason.

In an embodiment, when validation of each of the at least one information element is failed, the charging notify response comprises a second status code and error information related to the at least one information element.

In an embodiment, the second status code comprises a HTTP 404 Not Found or 400 In an embodiment, the error information related to the at least one information element comprises re-authorization is failed.

In an embodiment, the method may further comprise receiving a first message comprising information for indicating at least one supported feature of the charging function entity from the charging function entity. The method may further comprise sending a second message comprising information for indicating at least one supported feature of the network function entity to the charging function entity.

In an embodiment, the at least one supported feature comprises supporting for notification response in a network function consumer.

In an embodiment, the supporting for notification response in the network function consumer indicates that the notification response supports the first status code, the second status code and the error information.

In an embodiment, the first message comprises the charging notify request and the second message comprises the charging notify response.

In an embodiment, the network function entity is configured with a charging trigger function.

In an embodiment, the network function entity comprises at least one of Session Management Function (SMF), Packet Data Network Gateway (PGW), PGW control plane (PGW-C), or PGW-C combined with SMF.

In an embodiment, the charging notify request is used for converged session based charging.

In a third aspect of the disclosure, there is provided a charging function entity. The charging function entity comprises a processor and a memory coupled to the processor. Said memory contains instructions executable by said processor. Said charging function entity is operative to send a charging notify request comprising at least one information element to a network function entity. The at least one information element is used for determining which quota and/or usage reporting is required to be updated to the charging function entity. Said charging function entity is further operative to receive a charging notify response from the network function entity. When validation of a part of the at least one information element is failed, the charging notify response comprises a first status code and error information related to the part of the at least one information element.

In a fourth aspect of the disclosure, there is provided a network function entity. The network function entity comprises a processor and a memory coupled to the processor. Said memory contains instructions executable by said processor. Said network function entity is operative to receive a charging notify request comprising at least one information element from a charging function entity. The at least one information element is used for determining which quota and/or usage reporting is required to be updated to the charging function entity. Said network function entity is further operative to validate the at least one information element. Said network function entity is further operative to send a charging notify response to the charging function entity. When validation of a part of the at least one information element is failed, the charging notify response comprises a first status code and error information related to the part of the at least one information element.

In a fifth aspect of the disclosure, there is provided a charging function entity. The charging function entity comprises a first sending module configured to send a charging notify request comprising at least one information element to a network function entity. The at least one information element is used for determining which quota and/or usage reporting is required to be updated to the charging function entity. The charging function entity further comprises a first receiving module configured to receive a charging notify response from the network function entity. When validation of a part of the at least one information element is failed, the charging notify response comprises a first status code and error information related to the part of the at least one information element.

In an embodiment, the charging function entity further comprises a second sending module configured to send a first message comprising information for indicating at least one supported feature of the charging function entity to the network function entity

In an embodiment, the charging function entity further comprises a second receiving module configured to receive a second message comprising information for indicating at least one supported feature of the network function entity from the network function entity.

In a sixth aspect of the disclosure, there is provided a network function entity. The network function entity comprises a first receiving module configured to receive a charging notify request comprising at least one information element from a charging function entity. The at least one information element is used for determining which quota and/or usage reporting is required to be updated to the charging function entity. The network function entity further comprises a validating module configured to validate the at least one information element. The network function entity further comprises a first sending module configured to send a charging notify response to the charging function entity. When validation of a part of the at least one information element is failed, the charging notify response comprises a first status code and error information related to the part of the at least one information element.

In an embodiment, the network function entity further comprises a second receiving module configured to receive a first message comprising information for indicating at least one supported feature of the charging function entity from the charging function entity.

In an embodiment, the network function entity further comprises a second sending module configured to send a second message comprising information for indicating at least one supported feature of the network function entity to the charging function entity.

In a seventh aspect of the disclosure, there is provided a computer program product comprising instructions which when executed by at least one processor, cause the at least one processor to perform the method according to any one of the first and second aspects.

In an eighth aspect of the disclosure, there is provided a computer-readable storage medium storing instructions which when executed by at least one processor, cause the at least one processor to perform the method according to any one of the first and second aspects.

Embodiments herein may provide many advantages, of which a non-exhaustive list of examples follows. In some embodiments herein, the network function entity is able to handle the charging notify request when the information (such as Reauthorization Details information) in the charging function entity and the network function entity is inconsistent. In some embodiments herein, the charging function entity can know detailed error information when the charging notify request cannot be served by the network function entity. In some embodiments herein, the proposed solution can make the Reauthorization Details information be aligned between CHF and NF(CTF) after the PCC rules' activation, deactivation or modification to avoid unpredictable errors between the two NFs. In some embodiments herein, the proposed solution introduces a mechanism to inform the Reauthorization Details information inconsistence to CHF in Charing Notification Response message. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of session based charging notification with re-authorization;

FIG. 2 schematically shows a high level architecture in the fifth generation network;

FIG. 3 schematically shows a high level architecture in the fourth generation network;

FIG. 4 schematically shows a reference architecture for the Nchf interface;

FIG. 5 shows a flowchart of a method according to an embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present

disclosure;

FIG. 9 shows a flowchart of Nchf_ConvergedCharging_Notify service operation according to an embodiment of the present disclosure;

FIG. 10 is a block diagram showing an apparatus suitable for practicing some embodiments of the disclosure;

FIG. 11 is a block diagram showing a charging function entity according to an embodiment of the disclosure; and

FIG. 12 is a block diagram showing a network function entity according to an embodiment of the disclosure.

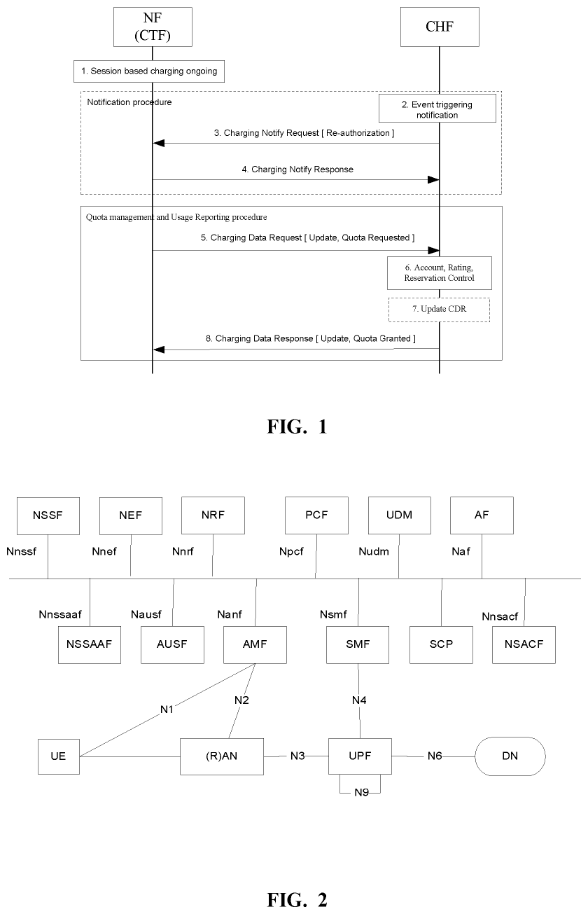

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable network entity which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN (Evolved Universal Terrestrial Radio Access Network) Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearable devices such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

Although the subject matter described herein may be implemented in any appropriate type of system using any suitable components, the embodiments disclosed herein are described in relation to a communication system complied with the exemplary system architectures illustrated in FIGS. 2-4. For simplicity, the system architectures of FIGS. 2-4 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 2 schematically shows a high level architecture in the fifth generation network according to an embodiment of the present disclosure. For example, the fifth generation network may be 5GS. The architecture of FIG. 2 is same as FIG. 4.2.3-1 as described in 3GPP TS 23.501 V17.0.0, the disclosure of which is incorporated by reference herein in its entirety. The system architecture of FIG. 2 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 2 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.0.0.

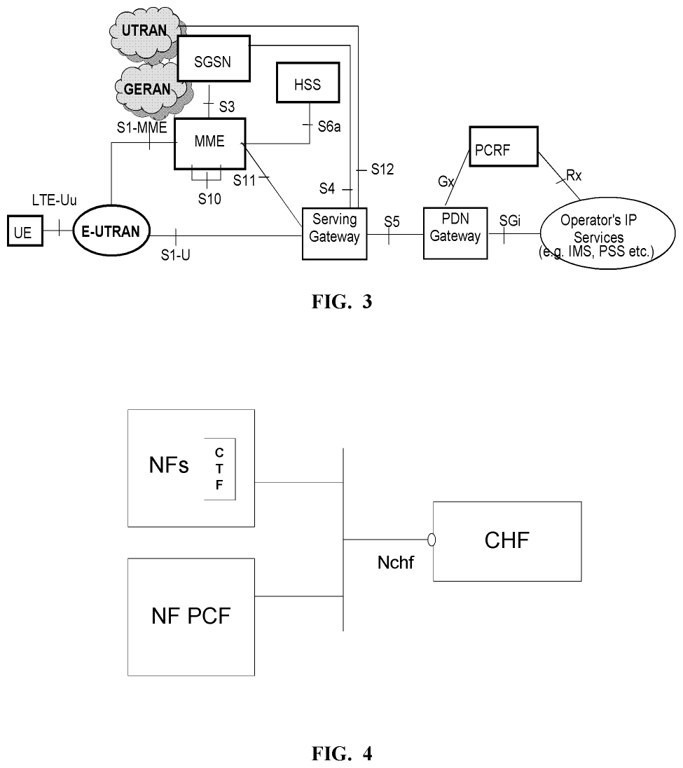

FIG. 3 schematically shows a high level architecture in the fourth generation network according to an embodiment of the present disclosure, which is the same as FIG. 4.2.1-1 of 3GPP TS 23.401 V17.0.0. The system architecture of FIG. 3 may comprise some exemplary elements such as UTRAN, GERAN (GSM EDGE (Enhanced Data rates for GSM Evolution) Radio Access Network), SGSN (Serving GPRS (General Packet Radio Service) Support Node), MME, HSS (Home Subscriber Server), E-UTRAN, serving gateway, PDN (Packet Data Network) gateway, PCRF (Policy and Charging Rules Function), etc.

There are some reference points as shown in FIG. 3.

S1-MME: Reference point for the control plane protocol between E-UTRAN and MME.

S1-U: Reference point between E-UTRAN and Serving GW (gateway) for the per bearer user plane tunnelling and inter eNodeB path switching during handover. S1-U does not apply to the Control Plane CIoT (Cellular Internet of Things) EPS Optimisation.

S3: It enables user and bearer information exchange for inter 3GPP access network mobility in idle and/or active state. This reference point can be used intra-PLMN or inter-PLMN (e.g. in the case of Inter-PLMN (Public Land Mobile Network) HO).

S4: It provides related control and mobility support between GPRS Core and the 3GPP Anchor function of Serving GW. In addition, if Direct Tunnel is not established, it provides the user plane tunnelling.

S5: It provides user plane tunnelling and tunnel management between Serving GW and PDN GW. It is used for Serving GW relocation due to UE mobility and if the Serving GW needs to connect to a non-collocated PDN GW for the required PDN connectivity.

S6a: It enables transfer of subscription and authentication data for authenticating/authorizing user access to the evolved system (AAA(Authentication, Authorization, Accounting) interface) between MME and HSS.

Gx: It provides transfer of (QOS) policy and charging rules from PCRF to Policy and Charging Enforcement Function (PCEF) in the PDN GW.

S11: Reference point providing control plane between MME and Serving GW. In addition, in order to support Control Plane CIoT EPS Optimisation, the S11-U reference point provides user plane between MME and Serving GW.

S12: Reference point between UTRAN and Serving GW for user plane tunnelling when Direct Tunnel is established. It is based on the Iu-u/Gn-u reference point using the GTP-U (GPRS Tunnelling Protocol for User Plane) protocol as defined between SGSN and UTRAN or respectively between SGSN and GGSN. Usage of S12 is an operator configuration option.

SGi: It is the reference point between the PDN GW and the packet data network. Packet data network may be an operator external public or private packet data network or an intra operator packet data network, e.g. for provision of IMS services. This reference point corresponds to Gi for 3GPP accesses.

Rx: The Rx reference point resides between the AF (application function) and the PCRF.

The network elements and reference points as shown in FIG. 3 may be same as the corresponding network elements and reference point as described in 3GPP TS 23.401 V17.0.0.

FIG. 4 schematically shows a reference architecture for the Nchf interface, which is the same as FIG. 4.2.1 of 3GPP TS 32.290 V17.1.0. As shown in FIG. 4, the NFs with CTF interact with CHF using Nchf interface for converged charging or offline only charging. The NF PCF interacts with CHF using Nchf interface for Spending Limit Control. The Nchf is a service based interface for NF and CHF.

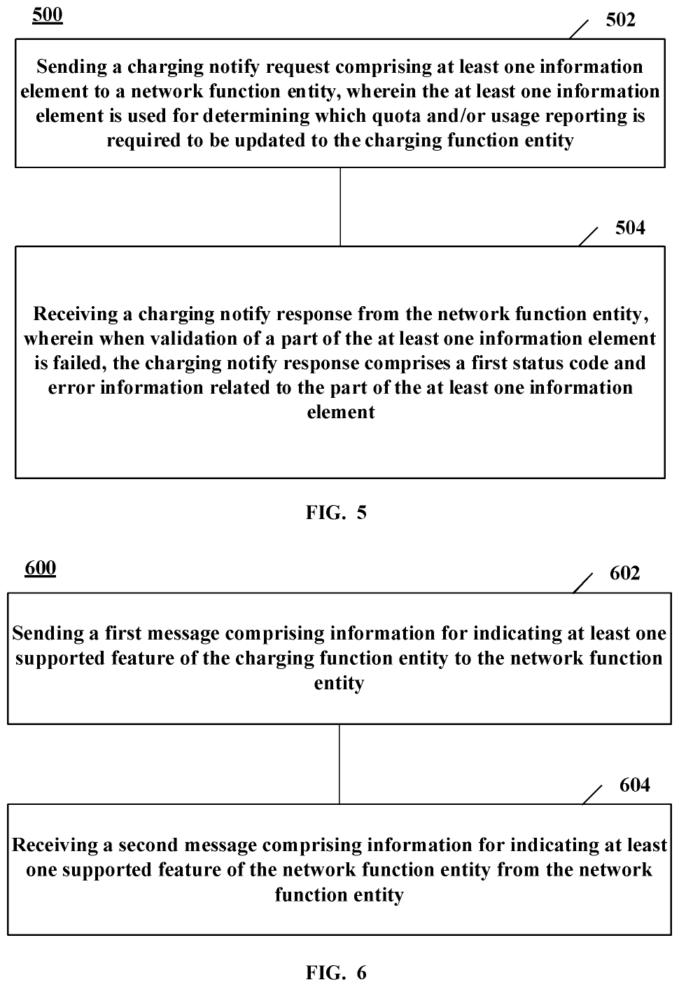

FIG. 5 shows a flowchart of a method according to an embodiment of the present disclosure, which may be performed by an apparatus implemented in or at or as a charging function entity or communicatively coupled to the charging function entity. As such, the apparatus may provide means or modules for accomplishing various parts of the method 500 as well as means or modules for accomplishing other processes in conjunction with other components. The charging function entity may be any suitable network device or node or entity or function which can provide charging function. For example, the charging function entity may be CHF as described in 3GPP TS 32.290 V17.1.0.

At block 502, the charging function entity may send a charging notify request

comprising at least one information element to a network function entity. The at least one information element is used for determining which quota and/or usage reporting is required to be updated to the charging function entity. The network function entity may be any suitable network function related to charging. For example, the network function entity may be SMF, PGW, PGW-C, PGW-C+SMF (PGW-C combined with SMF), or IMS (IP (Internet protocol) Multimedia Subsystem) node, etc. In an embodiment, the network function entity may comprise at least one of SMF, PGW, PGW-C, or PGW-C combined with SMF.

In an embodiment, the charging notify request may be used for converged session based charging for example as described in 3GPP TS 32.290 V17.1.0.

For example, the charging function entity can send the charging notify request to the network function entity such as NF (CTF). The network function entity such as NF (CTF) may implicitly subscribe to these when it sends an initial charging data request to the charging function entity, i.e. there is no separate subscription request from the NF for notification. Alternatively, the charging function entity can send a separate subscription request for notification to the charging function entity.

In an embodiment, there is a session based charging ongoing and there have at least been an initial charging data request sent from the NF (CTF) to the charging function entity. The charging function entity may have opened a CDR based on the initial charging data request.

The charging function entity may be triggered to send the charging notify request to the network function entity due to various reasons. In an embodiment, an event may be detected in the charging function entity that requires a notification to be sent to the network function entity. In this scenario a request for triggering a Charging Data Request [Update, Quota Request] is sent, but also requests for Charging Data Request [Update] (without request for quota) is possible.

In an embodiment, a specific information element may be used for determining that a specific quota and/or usage reporting corresponding to the specific information element is required to be updated to the charging function entity. When the charging notify request comprises two or more information elements, two or more specific quota and/or usage reporting may be required to be updated to the charging function entity.

The information element may comprises any suitable information. In an embodiment, information element may comprise at least one of service identifier, rating group, or quota management indicator. For example, the service identifier may be used to determine to a specific service to which quota and/or usage reporting notification applies. For example, if the service identifier is present, the rating group may also be present. For example, if the service identifier is not present, the quota and/or usage reporting notification applies to all service identifiers. For example, the rating group may be used to determine to a specific rating group to which the quota and/or usage reporting notification applies. For example, if the rating group is not present, the quota and/or usage reporting notification applies to all rating groups. The quota management indicator may be used to indicate whether the quota and/or usage reporting notification is for quota management control or not. For example, if the quota management indicator is not present, the quota and/or usage reporting notification applies to both units with and without quota management.

In an embodiment, an information element may be the information element of Reauthorization Details as described in Table 7.3 of 3GPP TS 32.290 V17.1.0.

In an embodiment, the charging notify request may comprise a type of notification indicating re-authorization. For example, the charging function entity may send a charging notify request with a notification type of re-authorization to the network function entity and the network function entity shall report the quota and/or usage related to the at least one information element to the charging function entity.

At block 504, the charging function entity may receive a charging notify response from the network function entity. The charging notify response may comprise any suitable information, such as the charging notify request is fully acknowledged, the charging notify request is partly acknowledged, the charging notify request is totally rejected, error information, etc.

After receiving the charging notify response, the charging function entity such as CHF may be able to decide what to do. For example, if the Service/RG (rating group) does not exist, It may close CDR for the corresponding RGs without waiting for the usage reporting for the service. If the charging method is changed (online to offline), it will not maintain the credit instance for the RG.

In an embodiment, when validation of a part of the at least one information element is failed (e.g., at least some information comprised in an information element cannot be found), the charging notify response comprises a first status code and error information related to the part of the at least one information element.

In an embodiment, when validation of a part of the at least one information element is failed (e.g., at least some information comprised in an information element cannot be found) and validation of the other part of the at least one information element is successful, the charging notify response comprises a first status code and error information related to the part of the at least one information element.

In an embodiment, when validation of each of the at least one information element is failed, the charging notify response comprises a second status code and error information related to the at least one information element.

In an embodiment, when validation of each of the at least one information element is successful, the charging notify response comprises a third status code. For example, the third status code may be HTTP 204 No Content status code indicating that the receipt of the notification is acknowledged.

In an embodiment, when the validation of each of the at least one information element indicates that the set of information needed by the NF entity to report the usage is incomplete or erroneous or not available (e.g. the rating group, service identifier specified in the request cannot be served by the NF consumer or there is no service that is quota management for the session or rating group and the request cannot be served by the NF consumer), the charging notify response comprises a second status code. For example, the second status code may be HTTP 400 Bad Request. As another example, the second status code may be HTTP 404 Not Found.

For example, the network function entity may check or validate the information comprised in an information element to determine whether the set of information needed by the network function entity to report the quota and/or usage is validated or incomplete or erroneous or not available. Alternatively, the network function entity may check or validate any information of an information element to determine whether the information element cannot be served by the network function entity.

In an embodiment, the validation of an information element may comprise checking whether some information comprised in an information element cannot be found.

In an embodiment, the charging notify request may be rejected because the service identifier specified in the charging notify request cannot be served by the network function entity.

In an embodiment, the charging notify request may be rejected because the rating group specified in the charging notify request cannot be served by the network function entity.

In an embodiment, the charging notify request may be rejected because there is no service that is quota management for the session or rating group and the request cannot be served by the network function entity.

The first status code may be any suitable status code only if it can indicate that the validation of the part of the at least one information element is failed and the validation of the other part of the at least one information element is successful.

In an embodiment, the first status code may comprise a Hypertext Transfer Protocol (HTTP) 200 OK status code indicating that the charging notify request is partly acknowledged.

The second status code may be any suitable status code only if it can indicate that the validation of each of the at least one information element is failed.

In an embodiment, the second status code may comprise an HTTP 404 Not Found or 400 Bad Request status code.

In an embodiment, when the charging notify response comprises the first status code, the first charging notify response may further comprise error information related to the part of the at least one information element. For example, when the validation of a specific information element is failed, the error information may comprises a specific error information corresponding to the specific information element. In an embodiment, each of the part of the at least one information element may have respective error information.

In an embodiment, the error information related to the part of the at least one information element comprises a failure reason. For example, the failure reason may indicate specific failure details.

In an embodiment, the error information related to the part of the at least one information element comprises re-authorization is only partly accepted.

In an embodiment, the error information related to the at least one information element comprises re-authorization is failed.

The error information may comprise any suitable error information for example depending on the information comprised in an information element. In an embodiment, the error information may be application errors.

In an embodiment, the error information may comprise at least one of a service identifier is not found, a rating group is not found, a quota management indicator is not found. For example, the error information of a service identifier is not found means that the information element comprising the service identifier cannot be served by the network function entity. The error information of a rating group is not found may means that the information element comprising the rating group cannot be served by the network function entity. The error information of a quota management indicator is not found may means that the information element comprising the quota management indicator cannot be served by the network function entity. The quota management indicator may be used for a session or a service or a rating group.

FIG. 6 shows a flowchart of a method according to another embodiment of the present disclosure, which may be performed by an apparatus implemented in or at or as a charging function entity or communicatively coupled to the charging function entity. As such, the apparatus may provide means or modules for accomplishing various parts of the method 600 as well as means or modules for accomplishing other processes in conjunction with other components. The charging function entity may be any suitable network device or node or entity or function which can provide charging function. For example, the charging function entity may be CHF as described in 3GPP TS 32.290 V17.1.0. For some parts which have been described in the above embodiments, the description thereof is omitted here for brevity.

At block 602, the charging function entity may send a first message comprising information for indicating at least one supported feature of the charging function entity to the network function entity. The

At block 604, the charging function entity may receive a second message comprising information for indicate at least one supported feature of the network function entity from the network function entity.

The at least one supported feature may comprise any suitable feature related to the charging. For example, the at least one supported feature may comprise at least one of the CHF-controlled quota management (i.e. support for temporary offline), the support of long character strings as charging identifiers, fifth generation system (5GS) interworking with EPC (Evolved Packet Core), the support of Access Traffic Steering, Switching, Splitting (ATSSS), the support of the enhanced diagnostics, the support for notification response in NF consumer, etc.

In an embodiment, the at least one supported feature may comprise supporting for notification response in a network function consumer.

In an embodiment, the supporting for notification response in the network function consumer may indicate that the notification response supports the first status code, the second status code and the error information.

The first message and the second message may be any suitable message which can be exchanged between the charging function entity and network function entity. In an embodiment, the first message may comprise the charging notify request. The second message may comprise the charging notify response.

In an embodiment, the at least one supported feature may be negotiated using the extensibility mechanism defined in subclause 6.6 of 3GPP TS 29.500 V17.2.0, the disclosure of which is incorporated by reference herein in its entirety.

In an embodiment, the network function entity is configured with a charging trigger function. The charging trigger function may generate charging data related to the delivered service and sends the charging data to the charging function entity.

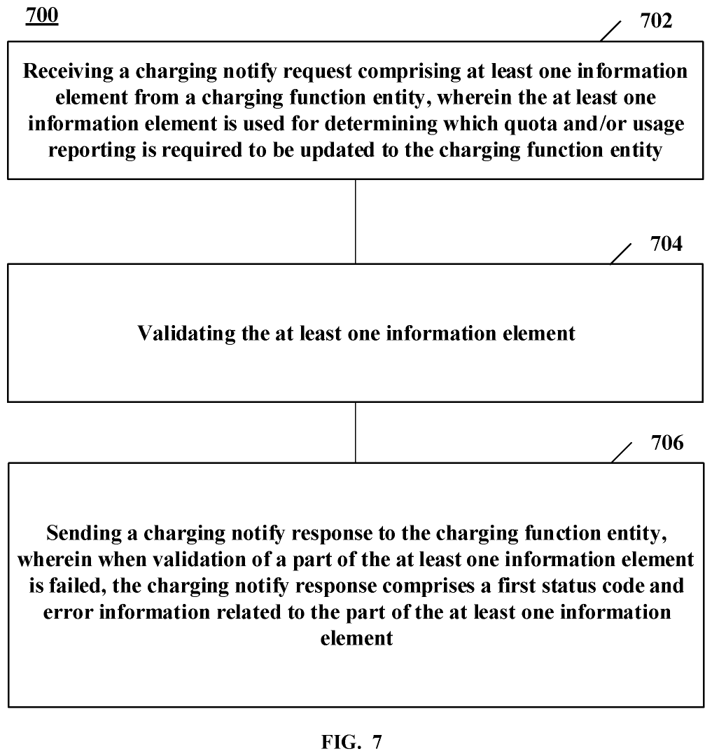

FIG. 7 shows a flowchart of a method according to another embodiment of the present disclosure, which may be performed by an apparatus implemented in or at or as a network function entity or communicatively coupled to the network function entity. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the network function entity may receive a charging notify request comprising at least one information element from a charging function entity. The at least one information element is used for determining which quota and/or usage reporting is required to be updated to the charging function entity.

At block 704, the network function entity may validate the at least one information element. The network function entity may validate the at least one information element in various ways. For example, the network function entity may validate whether information comprised in an information element can be found. When information comprised in an information element cannot be found, the validation of the information element is failed. Otherwise, the validation of the information element is successful. As another example, the network function entity may validate whether an information element comprises the set of information needed by the network function entity to report the usage. As still another example, the network function entity may validate whether an information element is incomplete or erroneous or not available.

In an embodiment, if the validating is failure, the network function entity such as SMF may have an approach to indicate the charging function entity such as CHF the inconsistent information between SMF and CHF. Then CHF may be able to decide what to do. For example, if the Service/RG (rating group) does not exist, It may close CDR for the corresponding RGs without waiting for the usage reporting for the service. If the charging method is changed (online to offline), it will not maintain the credit instance for the RG.

At block 706, the network function entity may send a charging notify response to the charging function entity. When validation of a part of the at least one information element is failed and validation of the other part of the at least one information element is successful, the charging notify response comprises a first status code and error information related to the part of the at least one information element.

In an embodiment, when validation of each of the at least one information element is failed, the charging notify response comprises a second status code and error information related to the at least one information element.

In an embodiment, when validation of a part of the at least one information element is failed (e.g., at least some information comprised in an information element cannot be found), the charging notify response comprises a first status code and error information related to the part of the at least one information element.

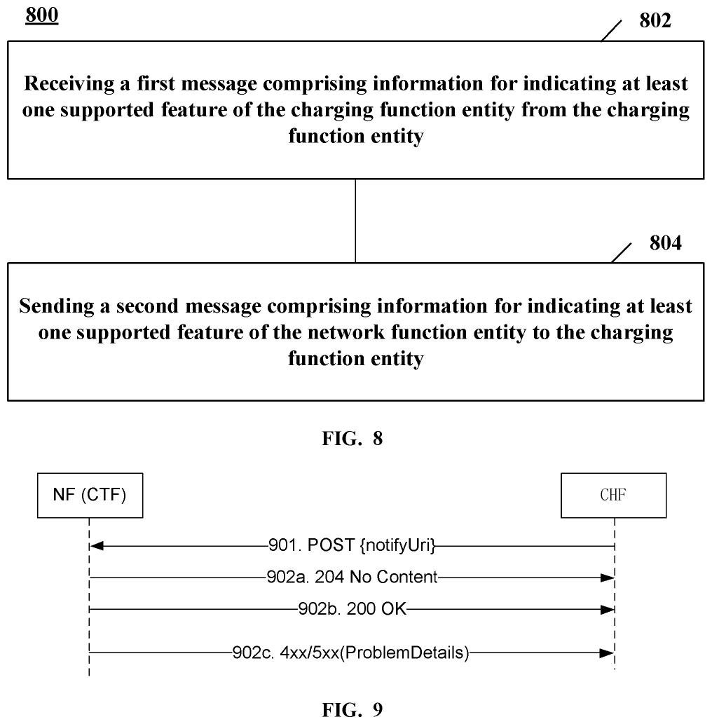

FIG. 8 shows a flowchart of a method according to another embodiment of the present disclosure, which may be performed by an apparatus implemented in or at or as a network function entity or communicatively coupled to the network function entity. As such, the apparatus may provide means or modules for accomplishing various parts of the method 800 as well as means or modules for accomplishing other processes in conjunction with other components. For some parts which have been described in the above embodiments, the description thereof is omitted here for brevity.

At block 802, the network function entity may receive a first message comprising information for indicating at least one supported feature of the charging function entity from the charging function entity.

At block 804, the network function entity may send a second message comprising information for indicating at least one supported feature of the network function entity to the charging function entity.

FIG. 9 shows a flowchart of Nchf_ConvergedCharging_Notify service operation according to an embodiment of the present disclosure.

The Nchf_ConvergedCharging Notify service operation provides means for CHF to notify the NF(CTF) to update or terminate charging of the PDU Session.

The following procedures using the Nchf_ConvergedCharging_Notify service operation are supported:
CHF determines re-authorization.
CHF determines abort of charging.

When NF(CTF) such as SMF receives Charging Notification Request with Reauthorization Details, if some of the re-authorized RG (rating group) or (RG+SI (service identifier)) is not match between CHF and NF(CTF), NF(CTF) can indicate the inconsistence status to CHF in Charging Notification Response message.

At step 901. The CHF sends a Nchf_ConvergedCharging_Notify request to the NF (CTF). The {notifyUri} identifies the notification URI which is sent in the Nchf_ConvergedCharging_Create request. The notification type is included in the request body.

At step 902a. At successful operation, “204 No Content” response is returned.

At step 902b. If the NF (CTF) receives Charging Notification Request with Reauthorization Details for one or more rating groups(rating group+service identifier) from CHF but the validation of some of them is unsuccessful, the NF (CTF) shall include an HTTP “200 OK” status code. If the validation for all the RG/RG+SI are failed because the rating group/rating group+service id/quota management indicator cannot served by the NF (CTF), the NF (CTF) shall include HTTP ‘404 NOT FOUND’ or ‘400 Bad Request’ status code. In an embodiment, for a 200 OK response, the message body shall contain a ProblemDetails structure with the “cause” attribute set to one of the application error listed in Tables 8a or 8b.

At step 902c. On failure, one of the HTTP status code listed in Table 4a or 4b shall be returned. For a 200/4xx/5xx response, the message body shall contain a ProblemDetails structure with the “cause” attribute set to one of the application error listed in Tables 8a or 8b.

In an embodiment, Table 6.1.5.2.3.1-2 of 3GPP TS 32.291 V16.7.0 may be amended as Table 4a.

TABLE 4a
Data structures supported by the POST Response Body on this resource

| | | | Response | |
|---|---|---|---|---|
| Data type | P | Cardinality | codes | Description |
| ChargingNotifyResponse | O | 1 | 200 OK | Partly acknowledge, see invocation |
| | | | | result for not accepted parts (NOTE 3) |
| n/a | | | 204 No | The receipt of the Notification |
| | | | Content | is acknowledged. |
| ChargingNotifyResponse | M | 1 | 400 Bad | (NOTE 2) (NOTE 3) |
| | | | Request | |
| ChargingNotifyResponse | O | 1 | 404 Not | (NOTE 2) (NOTE 3) |
| | | | Found | |

NOTE 1:
In addition, the HTTP status codes which are specified as mandatory in table 5.2.7.1-1 of 3GPP TS 29.500 V17.2.0 for the POST method also apply.
NOTE 2:
Failure cases are described in Tables 8a or 8b.
NOTE 3:
Should be supported if feature Notify_Response is supported see Table 7.

In an embodiment, Table 6.1.5.2.3.1-2 of 3GPP TS 32.291 V16.7.0 may be amended as Table 4b.

TABLE 4b
Data structures supported by the POST Response Body on this resource

| | | | Response | |
|---|---|---|---|---|
| Data type | P | Cardinality | codes | Description |
| ChargingNotifyResponse | O | 1 | 200 OK | Partly acknowledge, see invocation |
| | | | | result for not accepted parts (NOTE 3) |
| n/a | | | 204 No | The receipt of the Notification is |
| | | | Content | acknowledged. |
| ChargingNotifyResponse | M | 1 | 400 Bad | (NOTE 2) (NOTE 3) |
| | | | Request | |

NOTE 1:
In addition, the HTTP status codes which are specified as mandatory in table 5.2.7.1-1 of 3GPP TS 29.500 V17.2.0 for the POST method also apply.
NOTE 2:
Failure cases are described in Tables 8a or 8b.
NOTE 3:
Should be supported if feature Notify_Response is supported see Table 7.

Table 5 shows an example of charging notify response. In an embodiment, Table 6.1.6.2.1.16-1 of 3GPP TS 32.291 V16.7.0 may be amended as Table 5.

TABLE 5
ChargingNotifyResponse

| | | | | | |
|---|---|---|---|---|---|
| Attribute name | Data type | P | Cardinality | Description | Applicability |

| | | | | |
|---|---|---|---|---|
| invocationResult | InvocationResult | O_{C} | 0 . . . 1 | This field holds the result |
| | | | | of notification. |
| supportedFeatures | SupportedFeatures | O_{C} | 0 . . . 1 | This IE shall be present if |
| | | | | at least one optional feature |
| | | | | defined in Table 7 is supported. |

Table 6 shows an example of charging notify request. In an embodiment, Table 6.1.6.2.1.3-1 of 3GPP TS 32.291 V16.7.0 may be amended as Table 6.

TABLE 6
Definition of type ChargingNotifyRequest

| | | | | | |
|---|---|---|---|---|---|
| Attribute name | Data type | P | Cardinality | Description | Applicability |

| | | | | |
|---|---|---|---|---|
| notificationType | NotificationType | M | 1 | Type of notification to indicate |
| | | | | re-authorization or termination. |
| reauthorizationDetails | array(ReauthorizationDetails) | O_{C} | 0 . . . N | descriptors for re-authorization |
| | | | | to determine which quota or usage |
| | | | | reporting to be updated. |
| supportedFeatures | SupportedFeatures | O_{C} | 0 . . . 1 | This IE shall be present if at |
| | | | | least one optional feature defined |
| | | | | in Table 7 is supported. |

### Feature Negotiation

The optional features in Table 7 are defined for the Nchf_ConvergedCharging API of 3GPP TS 32.291 V16.7.0. They may be negotiated using the extensibility mechanism defined in subclause 6.6 of 3GPP TS 29.500 V17.2.0. In an embodiment, Table 6.1.8-1 of 3GPP TS 32.291 V16.7.0 may be amended as Table 7.

TABLE 7
Supported Features

| Feature | | |
|---|---|---|
| number | Feature Name | Description |
| 1 | CHFCQM | CHF-controlled quota |
| | | management i.e. support |
| | | for temporary offline |
| 2 | AF_Charging_Identifier | Indicates the support |
| | | of long character |
| | | strings as charging |
| | | identifiers. |
| 3 | 5GIEPC_CH | 5GS interworking with |
| | | EPC |
| 4 | ATSSS | This feature indicates |
| | | support of Access |
| | | Traffic Steering, |
| | | Switching, Splitting |
| | | (ATSSS). |
| 6 | EnhancedDiagnostics | Support the enhanced |
| | | diagnostics |
| 8 | Notify_Response | Support for |
| | | notification |
| | | response in NF |
| | | consumer |

### Application Errors

The application errors defined for the Nchf_ConvergedCharging API of 3GPP TS 32.291 V16.7.0 are listed in Tables 8a or 8b. The CHF shall include in the HTTP status code a “ProblemDetails” data structure with the “cause” attribute indicating the application error as listed in Tables 8a or 8b. The common application errors defined in the Table 5.2.7.2-1 in 3GPP TS 29.500 V17.2.0 may also be used for the Nchf_ConvergedCharging service. In an embodiment, Table 6.1.7.3-1 of 3GPP TS 32.291 V16.7.0 may be amended as Table 8a.

TABLE 8a
Application errors

| | HTTP | |
|---|---|---|
| Application Error | status code | Description |
| CHARGING_FAILED | 400 Bad Request | The HTTP request is rejected because the |
| | | set of session or subscriber information |
| | | needed by the CHF for charging or CDR |
| | | creation is incomplete or erroneous or not |
| | | available. (E.g. Rating Group, subscriber |
| | | information) |
| RE_AUTHORIZATION_FAILED | 400 Bad Request | The HTTP request is rejected because |
| | | the set of information needed by the |
| | | NF Consumer (CTF) to report the usage |
| | | is incomplete or erroneous or not available. |
| CHARGING_NOT_APPLICABLE | 403 Forbidden | The HTTP request is rejected by the CHF |
| | | since it has been determined that the |
| | | service can be allowed to the end user |
| | | without any charging or CDR creation. |
| USER_UNKNOWN | 404 Not Found | The HTTP request is rejected because the |
| | | end user specified in the request cannot |
| | | be served by the CHF. |
| END_USER REQUEST_DENIED | 403 Forbidden | The HTTP request denied by the CHF due |
| | | to restrictions or limitations related |
| | | to the end-user. |
| QUOTA_LIMIT_REACHED | 403 Forbidden | The HTTP request denied by the CHF because |
| | | the end user's account could not cover |
| | | the requested service. If the request |
| | | contained used units they are deducted, |
| | | if applicable. |
| END_USER_REQUEST_REJECTED | 403 Forbidden | The HTTP request rejected by the CHF due |
| | | to end-user restrictions or limitations. |
| RE_AUTHORIZATION_PARTLY | 200 OK | The HTTP request is only partly accepted, |
| | | see invocation result for not accepted parts. |
| SERVICE_ID_NOT_FOUND | 200 OK | The HTTP request is only partly accepted |
| | | because the service identifier specified |
| | | in the request cannot be served by the |
| | | NF consumer. |
| RATING_GROUP_NOT_FOUND | 200 OK | The HTTP request is only partly accepted |
| | | because the rating group specified in the |
| | | request cannot be served by the NF consumer. |
| QUOTA_MANAGEMENT_NOT_FOUND | 200 OK | The HTTP request is only partly accepted |
| | | because there is no service that is quota |
| | | management for the session or rating group |
| | | and the request cannot be served by the NF |
| | | consumer. |

In an embodiment, Table 6.1.7.3-1 of 3GPP TS 32.291 V16.7.0 may be amended as Table 8b.

TABLE 8b
Application errors

| Application Error | HTTP status code | Description |
|---|---|---|
| RE_AUTHORIZATION_PARTLY | 200 OK | The HTTP request is only partly accepted, see |
| | | invocation result for not accepted parts. |
| CHARGING_FAILED | 400 Bad Request | The HTTP request is rejected because the set |
| | | of session or subscriber information needed |
| | | by the CHF for charging or CDR creation is |
| | | incomplete or erroneous or not available. (E.g. |
| | | Rating Group, subscriber information) |
| RE_AUTHORIZATION_FAILED | 400 Bad Request | The HTTP request is rejected because the set |
| | | of information needed by the NF Consumer (CTF) |
| | | to report the usage is incomplete or erroneous |
| | | or not available. (e.g. The rating bgroup, |
| | | service identifier specified in the request |
| | | cannot be served by the NF consumer or there is |
| | | no service that is quota management for the |
| | | session or rating group and the request cannot |
| | | be served by the NF consumer) |
| CHARGING_NOT_APPLICABLE | 403 Forbidden | The HTTP request is rejected by the CHF since |
| | | it has been determined that the service can be |
| | | allowed to the end user without any charging |
| | | or CDR creation. |
| USER_UNKNOWN | 404 Not Found | The HTTP request is rejected because the end |
| | | user specified in the request cannot be served |
| | | by the CHF. |
| END_USER REQUEST_DENIED | 403 Forbidden | The HTTP request denied by the CHF due to |
| | | restrictions or limitations related to the |
| | | end-user. |
| QUOTA_LIMIT_REACHED | 403 Forbidden | The HTTP request denied by the CHF because |
| | | the end user's account could not cover |
| | | the requested service. If the request |
| | | contained used units they are deducted, if |
| | | applicable. |
| END_USER_REQUEST_REJECTED | 403 Forbidden | The HTTP request rejected by the CHF due |
| | | to end-user restrictions or limitations. |

In an embodiment, Nchf_ConvergedCharging API of 3GPP TS 32.291 V16.7.0 may be amended as following.

### A.2 Nchf_ConvergedCharging API

```
openapi: 3.0.0
info:
  title: Nchf_ConvergedCharging
  version: 3.0.2
  description: |
    ConvergedCharging Service  © 2020, 3GPP Organizational Partners (ARIB, ATIS, CCSA, ETSI, TSDSI,
TTA, TTC).
    All rights reserved.
externalDocs:
  description: >
    3GPP TS 32.291 V16.7.0: Telecommunication management; Charging management;
    5G system, charging service; Stage 3.
  url: ‘http://www.3gpp.org/ftp/Specs/archive/32_series/32.291/’
servers:
  - url: ‘{apiRoot}/nchf-convergedcharging/v3’
    variables:
      apiRoot:
        default: https://example.com
        description: apiRoot as defined in subclause 4.4 of 3GPP TS 29.501.
security:
  - { }
  - oAuth2ClientCredentials:
    - nchf-convergedcharging
paths:
  /chargingdata:
    post:
      requestBody:
        required: true
        content:
          application/json:
            schema:
              $ref: ‘#/components/schemas/ChargingDataRequest’
      responses:
        ‘201’:
          description: Created
          content:
            application/json:
              schema:
                $ref: ‘#/components/schemas/ChargingDataResponse’
        ‘400’:
          description: Bad request
          content:
            application/problem+json:
              schema:
                $ref: ‘TS29571_CommonData.yaml#/components/schemas/ProblemDetails’
        ‘403’:
          description: Forbidden
          content:
            application/problem+json:
              schema:
                $ref: ‘TS29571_CommonData.yaml#/components/schemas/ProblemDetails’
        ‘404’:
          description: Not Found
          content:
            application/problem+json:
              schema:
                $ref: ‘TS29571_CommonData.yaml#/components/schemas/ProblemDetails’
        ‘401’:
          $ref: ‘TS29571_CommonData.yaml#/components/responses/401’
        ‘410’:
          $ref: ‘TS29571_CommonData.yaml#/components/responses/410’
        ‘411’:
          $ref: ‘TS29571_CommonData.yaml#/components/responses/411’
        ‘413’:
          $ref: ‘TS29571_CommonData.yaml#/components/responses/413’
        ‘500’:
          $ref: ‘TS29571_CommonData.yaml#/components/responses/500’
        ‘503’:
          $ref: ‘TS29571_CommonData.yaml#/components/responses/503’
        default:
          $ref: ‘TS29571_CommonData.yaml#/components/responses/default’
      callbacks:
        chargingNotification:
          ‘{$request.body#/notifyUri}’:
            post:
              requestBody:
                required: true
                content:
                  application/json:
                    schema:
                      $ref: ‘#/components/schemas/ChargingNotifyRequest’
              responses:
                ‘200’:
                  description: OK
                  content:
                    application/json:
                      schema:
                        $ref: ‘#/components/schemas/ChargingNotifyResponse’
                ‘204’:
                  description: ‘No Content, Notification was succesfull’
                ‘400’:
                  description: Bad request
                  content:
                      application/problem+json:
                        schema:
                          oneOf:
                            $ref: TS29571_CommonData.yaml#/components/schemas/ProblemDetails
                            $ref: ‘#/components/schemas/ChargingNotifyResponse’
                ‘404’:
                  description: Not Found
                  content:
                    schema:
                      $ref: ‘#/components/schemas/ChargingNotifyResponse’
                default:
                  $ref: ‘TS29571_CommonData.yaml#/components/responses/default’
```

******the following text is omitted for brevity******

In an embodiment, Nchf_ConvergedCharging API of 3GPP TS 32.291 V16.7.0 may be amended as following.

### A.2 Nchf_ConvergedCharging API

```
openapi: 3.0.0
info:
  title: Nchf_ConvergedCharging
  version: 3.0.2
  description: |
    ConvergedCharging Service  © 2020, 3GPP Organizational Partners (ARIB, ATIS, CCSA, ETSI, TSDSI,
TTA, TTC).
    All rights reserved.
externalDocs:
  description: >
    3GPP TS 32.291 V16.7.0: Telecommunication management; Charging management;
    5G system, charging service; Stage 3.
  url: ‘http://www.3gpp.org/ftp/Specs/archive/32_series/32.291/’
servers:
  - url: ‘{apiRoot}/nchf-convergedcharging/v3’
    variables:
      apiRoot:
        default: https://example.com
        description: apiRoot as defined in subclause 4.4 of 3GPP TS 29.501.
security:
  - { }
  - oAuth2ClientCredentials:
    - nchf-convergedcharging
paths:
  /chargingdata:
    post:
      requestBody:
        required: true
        content:
          application/json:
            schema:
              $ref: ‘#/components/schemas/ChargingDataRequest’
      responses:
        ‘201’:
          description: Created
          content:
            application/json:
              schema:
                $ref: ‘#/components/schemas/ChargingDataResponse’
        ‘400’:
          description: Bad request
          content:
            application/problem+json:
              schema:
                $ref: ‘TS29571_CommonData.yaml#/components/schemas/ProblemDetails’
        ‘403’:
          description: Forbidden
          content:
            application/problem+json:
              schema:
                $ref: ‘TS29571_CommonData.yaml#/components/schemas/ProblemDetails’
        ‘404’:
          description: Not Found
          content:
            application/problem+json:
              schema:
                $ref: ‘TS29571_CommonData.yaml#/components/schemas/ProblemDetails’
        ‘401’:
          $ref: ‘TS29571_CommonData.yaml#/components/responses/401’
        ‘410’:
          $ref: ‘TS29571_CommonData.yaml#/components/responses/410’
        ‘411’:
          $ref: ‘TS29571_CommonData.yaml#/components/responses/411’
        ‘413’:
          $ref: ‘TS29571_CommonData.yaml#/components/responses/413’
        ‘500’:
          $ref: ‘TS29571_CommonData.yaml#/components/responses/500’
        ‘503’:
          $ref: ‘TS29571_CommonData.yaml#/components/responses/503’
        default:
          $ref: ‘TS29571_CommonData.yaml#/components/responses/default’
      callbacks:
        chargingNotification:
          ‘{$request.body#/notifyUri}’:
            post:
              requestBody:
                required: true
                content:
                  application/json:
                    schema:
                      $ref: ‘#/components/schemas/ChargingNotifyRequest’
              responses:
                ‘200’:
                  description: OK
                  content:
                    application/json:
                      schema:
                        $ref: ‘#/components/schemas/ChargingNotifyResponse’
                ‘204’:
                  description: ‘No Content, Notification was succesfull’
                ‘400’:
                  description: Bad request
                  content:
                      application/problem+json:
                        schema:
                          oneOf:
                            $ref: TS29571_CommonData.yaml#/components/schemas/ProblemDetails
                            $ref: ‘#/components/schemas/ChargingNotifyResponse’
                default:
                  $ref: ‘TS29571_CommonData.yaml#/components/responses/default’
```

******the following text is omitted for brevity******

In an embodiment, a new data type reauthorizationFailureDetails to indicate the error cause and which RG/RG+SI is failure is shown in Tables 9-11.

Table 9 shows an example of charging notify response. In an embodiment, Table 6.1.6.2.1.16-1 of 3GPP TS 32.291 V16.7.0 may be amended as Table 9.

TABLE 9
ChargingNotifyResponse

| | | | | | |
|---|---|---|---|---|---|
| Attribute name | Data type | P | Cardinality | Description | Applicability |

| | | | | |
|---|---|---|---|---|
| invocationResult | InvocationResult | O_{C} | 0 . . . 1 | This field holds the result of |
| | | | | notification. |
| reauthorizationFailureDetails | array(ReauthorizationFailureDetails) | O_{C} | 0 . . . N | It's only present when type of |
| | | | | notification isre-authorization |
| | | | | and the status of partial RGs or |
| | | | | RG + SI is inconsistent between |
| | | | | SMF and CHF(http status 200 ok |

Table 10 shows an example of reauthorization Failure Details.

TABLE 10
reauthorizationFailureDetails

| | | | | | |
|---|---|---|---|---|---|
| Attribute name | Data type | P | Cardinality | Description | Applicability |

| | | | | |
|---|---|---|---|---|
| failureCause | ResultCode | M | 1 | Application error cause specific |
| | | | | to this report. |
| service | ServiceId | O_{C} | 0 . . . 1 | Identifier for a service which |
| | | | | doesn't exist or the applied |
| | | | | charging method for the service |
| | | | | in SMF is inconsistent with the |
| | | | | quotaManagementIndicator from CHF. |
| ratingGroup | RatingGroup | O_{C} | 0 . . . 1 | Identifier of a rating group which |
| | | | | doesn't exist or the applied |
| | | | | charging method for the RG in SMF |
| | | | | is inconsistent with the |
| | | | | quotaManagementIndicator from CHF. |
| | | | | This attribute shall be present if |
| | | | | serviceIdentifier attribute is present. |

Table 11 shows an example of enumeration result code.

TABLE 11
Enumeration ResultCode

| | | |
|---|---|---|
| Enumeration value | Description | Applicability |

| | |
|---|---|
| SERVICE_ID_NOT_EXIST | Service Identifier to which re- |
| | authorization notification applies |
| | does not exist. |
| RATING_GROUP_NOT_EXIST | Rating group to which re-authorization |
| | notification applies does not exist. |
| QUOTA_MANAGEMENT_INDICATOR_MISMATCH | The online and offline status of an |
| | RG or RG + SI in CTF is inconsistent |
| | with the one received from CHF through |
| | Quota management Indicator when type of |
| | notification is re-authorization. |

Embodiments herein may provide many advantages, of which a non-exhaustive list of examples follows. In some embodiments herein, the network function entity is able to handle the charging notify request when the information (such as Reauthorization Details information) in the charging function entity and the network function entity is inconsistent. In some embodiments herein, the charging function entity can know detailed error information when the charging notify request cannot be served by the network function entity. In some embodiments herein, the proposed solution can make the Reauthorization Details information be aligned between CHF and NF(CTF) after the PCC rules' activation, deactivation or modification to avoid unpredictable errors between the two NFs. In some embodiments herein, the proposed solution introduces a mechanism to inform the Reauthorization Details information inconsistence to CHF in Charing Notification Response message. The embodiments herein are not limited to the features and advantages mentioned above. A person skilled in the art will recognize additional features and advantages upon reading the following detailed description.

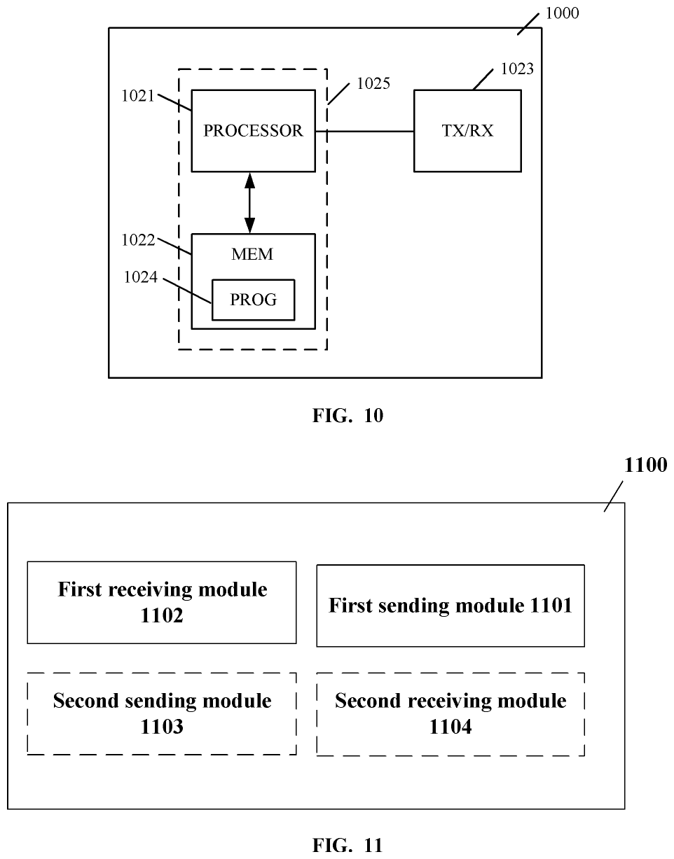

FIG. 10 is a block diagram showing an apparatus suitable for practicing some embodiments of the disclosure. For example, any one of the charging function entity or network function entity described above may be implemented as or through the apparatus 1000.

The apparatus 1000 comprises at least one processor 1021, such as a digital processor (DP), and at least one memory (MEM) 1022 coupled to the processor 1021. The apparatus 1000 may further comprise a transmitter TX and receiver RX 1023 coupled to the processor 1021. The MEM 1022 stores a program (PROG) 1024. The PROG 1024 may include instructions that, when executed on the associated processor 1021, enable the apparatus 1000 to operate in accordance with the embodiments of the present disclosure. A combination of the at least one processor 1021 and the at least one MEM 1022 may form processing means 1025 adapted to implement various embodiments of the present disclosure.

Various embodiments of the present disclosure may be implemented by computer program executable by one or more of the processor 1021, software, firmware, hardware or in a combination thereof.

The MEM 1022 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1021 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the charging function entity, the memory 1022 contains instructions executable by the processor 1021, whereby the charging function entity operates according to any of the methods related to the charging function entity as described above.

In an embodiment where the apparatus is implemented as or at the network function entity, the memory 1022 contains instructions executable by the processor 1021, whereby the network function entity operates according to any of the methods related to the network function entity as described above.

FIG. 11 is a block diagram showing a charging function entity according to an embodiment of the disclosure. As shown, the charging function entity 1100 comprises a first sending module 1101 configured to send a charging notify request comprising at least one information element to a network function entity. The at least one information element is used for determining which quota and/or usage reporting is required to be updated to the charging function entity. The charging function entity 1100 further comprises a first receiving module 1102 configured to receive a charging notify response from the network function entity. When validation of a part of the at least one information element is failed, the charging notify response comprises a first status code and error information related to the part of the at least one information element.

In an embodiment, the charging function entity 1100 further comprises a second sending module 1103 configured to send a first message comprising information for indicating at least one supported feature of the charging function entity to the network function entity

In an embodiment, the charging function entity 1100 further comprises a second receiving module 1104 configured to receive a second message comprising information for indicating at least one supported feature of the network function entity from the network function entity.

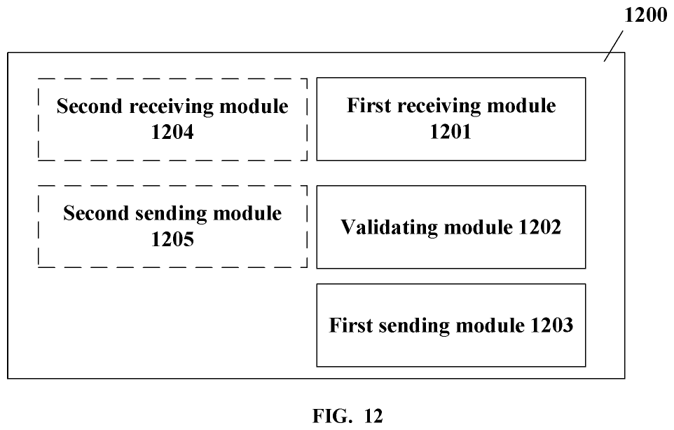

FIG. 12 is a block diagram showing a network function entity according to an embodiment of the disclosure. As shown, the network function entity 1200 comprises a first receiving module 1201 configured to receive a charging notify request comprising at least one information element from a charging function entity. The at least one information element is used for determining which quota and/or usage reporting is required to be updated to the charging function entity. The network function entity 1200 further comprises a validating module 1202 configured to validate the at least one information element. The network function entity 1200 further comprises a first sending module 1203 configured to send a charging notify response to the charging function entity. When validation of a part of the at least one information element is failed, the charging notify response comprises a first status code and error information related to the part of the at least one information element.

In an embodiment, the network function entity 1200 further comprises a second receiving module 1204 configured to receive a first message comprising information for indicating at least one supported feature of the charging function entity from the charging function entity.

In an embodiment, the network function entity 1200 further comprises a second sending module 1205 configured to send a second message comprising information for indicating at least one supported feature of the network function entity to the charging function entity.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the charging function entity or the network function entity may not need a fixed processor or memory, any computing resource and storage resource may be arranged from the charging function entity or the network function entity in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an

apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a charging function entity, comprising:
sending a charging notify request comprising at least one information element to a network function entity, wherein the at least one information element is used for determining which quota and/or usage reporting is required to be updated to the charging function entity; and
receiving a charging notify response from the network function entity,
wherein when validation of a part of the at least one information element is failed, the charging notify response comprises a first status code and error information related to the part of the at least one information element.

2. The method according to claim 1, wherein the at least one information element comprises at least one of:
service identifier,
rating group, or
quota management indicator.

3. The method according to claim 1, wherein the charging notify request comprises a type of notification indicating re-authorization, and wherein the error information related to the at least one information element comprises re-authorization is failed.

4. The method according to claim 1, wherein the first status code comprises a status code indicating that the charging notify request is at least partly acknowledged.

5. The method according to claim 1, wherein the error information related to the part of the at least one information element comprises a failure reason.

6. The method according to claim 1, wherein when validation of each of the at least one information element is failed, the charging notify response comprises a second status code and error information related to the at least one information element.

7. The method according to claim 6, wherein the second status code comprises a HTTP 404 Not Found or 400 Bad Request status code.

8. (canceled)

9. The method according to claim 1, further comprising:
sending a first message comprising information for indicating at least one supported feature of the charging function entity to the network function entity; and
receiving a second message comprising information for indicating at least one supported feature of the network function entity from the network function entity.

10. The method according claim 9, wherein the at least one supported feature comprises supporting for notification response in a network function consumer.

11. The method according to claim 10, wherein the supporting for notification response in the network function consumer indicates that the notification response supports the first status code, the second status code and the error information.

12. The method according to claim 9, wherein the first message comprises the charging notify request and the second message comprises the charging notify response.

13. (canceled)

14. (canceled)

15. (canceled)

16. A method performed by a network function entity, comprising:
receiving a charging notify request comprising at least one information element from a charging function entity, wherein the at least one information element is used for determining which quota and/or usage reporting is required to be updated to the charging function entity; and
validating the at least one information element; and
sending a charging notify response to the charging function entity,
wherein when validation of a part of the at least one information element is failed, the charging notify response comprises a first status code and error information related to the part of the at least one information element.

17. (canceled)

18. The method according to claim 16, wherein the charging notify request comprises a type of notification indicating re-authorization, and wherein the error information related to at least one information element comprises re authorization is failed.

19. The method according to claim 16, wherein the first status code comprises a status code indicating that the charging notify request is at least partly acknowledged.

20. (canceled)

21. The method according to claim 16, wherein when validation of each of the at least one information element is failed, the charging notify response comprises a second status code and error information related to the at least one information element.

22. The method according to any of claims 21, wherein the second status code comprises a HTTP 404 Not Found or 400 Bad Request status code.

23. (canceled)

24. The method according to claim 16, further comprising:
receiving a first message comprising information for indicating at least one supported feature of the charging function entity from the charging function entity; and
sending a second message comprising information for indicating at least one supported feature of the network function entity to the charging function entity;
wherein the first message comprises the charging request and the second message comprises the charging notify response.

25. The method according claim 24, wherein the at least one supported feature comprises supporting for notification response in a network function consumer.

26. The method according to claim 25, wherein the supporting for notification response in the network function consumer indicates that the notification response supports the first status code, the second status code and the error information.

27. (canceled)

28. (canceled)

29. (canceled)

30. (canceled)

31. A charging function entity, comprising:
a processor; and
a memory coupled to the processor, said memory containing instructions executable by said processor, whereby said charging function entity is operative to:
send a charging notify request comprising at least one information element to a network function entity, wherein the at least one information element is used for determining which quota and/or usage reporting is required to be updated to the charging function entity; and
receive a charging notify response from the network function entity,
wherein when validation of a part of the at least one information element is failed, the charging notify response comprises a first status code and error information related to the part of the at least one information element.

32. The charging function entity according to claim 31, wherein the first status code comprises a status code indicating that the charging notify request is at least partly acknowledged.

33. A network function entity, comprising:
a processor; and
a memory coupled to the processor, said memory containing instructions executable by said processor, whereby said network function entity is operative to:
receive a charging notify request comprising at least one information element from a charging function entity, wherein the at least one information element is used for determining which quota and/or usage reporting is required to be updated to the charging function entity; and
validate the at least one information element; and
send a charging notify response to the charging function entity,
wherein when validation of a part of the at least one information element is failed, the charging notify response comprises a first status code and error information related to the part of the at least one information element.

34. The network function entity according to claim 33, wherein the first status code comprises a status code indicating that the charging notify request is at least partly acknowledged.

35. (canceled)

36. (canceled)
